(19) United States
(12) Patent Application Publication
(10) Pub. No.: US 2005/0219576 A1
(43) Pub. Date: Oct. 6, 2005

(54) Image scanning method and apparatus

(75) Inventor: Dae-Gon Eun, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/025,150

(22) Filed: Dec. 30, 2004

(30) Foreign Application Priority Data
Jan. 9, 2004 (KR) 10-2004-0001423

(51) Int. Cl. H04N 1/40; G06K 15/00; H04N 1/04; H04N 1/409

(52) U.S. Cl. 358/1.9; 358/474; 358/488; 358/3.26

(57) ABSTRACT

An image scanning method and apparatus for edge detection and background image removal performed by a single operation. The image scanning method includes moving an image sensor in a first direction and detecting an edge of a document, and moving the image sensor in a second direction and detecting a gray level of a background image of the document. Accordingly, both document edge detection and background image removal can be performed by only a single operation of the image sensor, thereby, reducing scanning times.

### CROSS-REFERENCE TO RELATED APPLICATIONS

This application claims the benefit under 35 U.S.C. §119(a) of Korean Patent Application No. 10-2004-0001423, filed in the Korean Intellectual Property Office on Jan. 9, 2004, the entire contents of which are hereby incorporated by reference.

### BACKGROUND OF THE INVENTION

1. Field of the Invention

The present invention relates to technology of scanning a document using a scanner or an apparatus having a scanning function. More particularly, the present invention relates to an image scanning method and apparatus by which edge detection and background image removal are performed together.

2. Description of the Related Art

In a conventional scanning apparatus, edge detection and background image removal are separately performed with respect to a document. Edge detection is a function that detects an edge of a document to adjust a size of an image on the document. When the edge of the document is detected, a size of an image on the document can be adjusted to a size of a print paper.

The background image removal is a function that removes a background image from the document so that a user can reconstruct an image on the document to be suitable to the user's needs. For example, if a user wants to scan only text information on newspaper, the gray color used as typical background color of newspaper is not important or desired. In this example, the background image removal may be used to remove the background gray color, and the user can obtain the text information with a white background.

In order to perform the edge detection and the background image removal, an image needs to be read. Conventionally, since an image sensor reading an image is separately operated for edge detection and background image removal, the entire scanning time is increased.

Accordingly, a need exists for a system and method for edge detection and background image removal performed by a single operation to thereby reduce scanning times.

### SUMMARY OF THE INVENTION

The present invention substantially solves the above and other problems by providing an image scanning method by which both edge detection and background image removal are performed by a single operation of an image sensor.

The present invention also provides an image scanning apparatus in which both edge detection and background image removal are performed by a single operation of an image sensor.

According to an aspect of the present invention, an image scanning method is provided including steps for moving an image sensor in a first direction and detecting an edge of a document, and moving the image sensor in a second direction and detecting a gray level of a background image of the document.

According to another aspect of the present invention, an image scanning apparatus is provided including an image read controller for controlling image reading using the image sensor moving in a first direction and a second direction, an edge detector for detecting an edge of a document, a background gray level detector for detecting a gray level of a background image of the document, and a detection completion sensor for sensing whether the edge detector completes detecting the edge of the document, or sensing whether the background gray level detector completes detecting the gray level of the background image.

### BRIEF DESCRIPTION OF THE DRAWINGS

The above and other features and advantages of the present invention will become more apparent by describing in detail exemplary embodiments thereof with reference to the attached drawings, in which:

FIG. 1 is a flowchart of an image scanning method according to an embodiment of the present invention;

FIG. 2 is a flowchart of an embodiment of the operation of step 12 shown in FIG. 1;

FIG. 3 is a flowchart of an embodiment of the operation of step 14 shown in FIG. 1; and

FIG. 4 is a block diagram of an image scanning apparatus according to an embodiment of the present invention.

Throughout the drawings, like reference numerals will be understood to refer to like parts, components and structures.

### DETAILED DESCRIPTION OF EXEMPLARY EMBODIMENTS

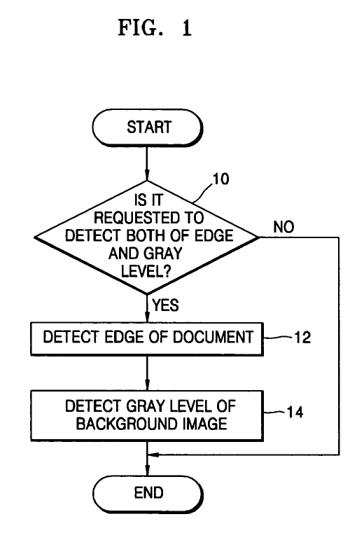

Referring to FIG. 1, an image scanning method includes moving an image sensor in a first direction to detect an edge of a document and moving the image sensor in a second direction to detect a gray level of a background image of the document in the operations of steps 10 through 14.

In the flow chart of FIG. 1, it is first determined whether there is a request to detect both the edge of the document and the gray level of the background image of the document together in the operation of step 10. If it is determined that detecting both the edge and the gray level together is not requested, the image scanning method is ended.

However, if it is determined that detecting both the edge and the gray level together is requested, the image sensor is moved in the first direction and detects the edge of the document in the operation of step 12. The first direction is a direction in which the image sensor moves to read an image.

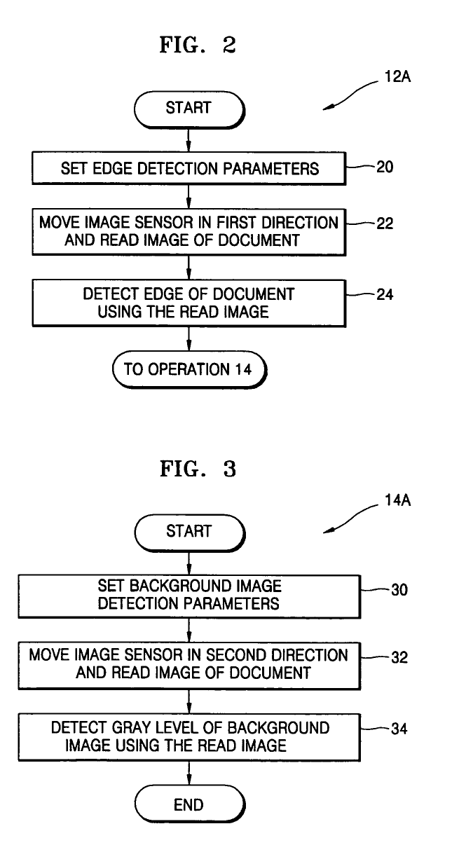

FIG. 2 is a flowchart 12A of an embodiment of the operation of step 12 shown in FIG. 1, which includes reading an image of the document using the image sensor and detecting the edge of the document in the operations of steps 20 through 24.

Edge detection parameters used to detect an edge of a document are first set in the operation of step 20. Examples of the edge detection parameters may include a threshold gray level for determining an edge or a non-edge of the document, a value defining a size of an image, and other usual parameters that can be set for edge detection.

After the operation of step 20, the image sensor is moved in the first direction and reads the image of the document in the operation of step 22. Conventionally, an image sensor reads an image while moving from one side to an opposite side, such as in the first direction, and then the image sensor returns to an original position and waits. However, in an embodiment of the present invention, after reading an image while moving in the first direction, the image sensor does not return to the original position, but waits at the opposite side to perform the operation of step 14. Since the image sensor reads an image of a document in a conventional manner, a detailed description thereof will be omitted.

After the operation of step 22, the image sensor detects the edge of the document using the read image based on the edge detection parameters in the operation of step 24. The edge detection is performed in a conventional manner, therefore, a detailed description thereof will be omitted.

Returning to FIG. 1, after the operation of step 12, if it is determined that the edge detection is completed, the image sensor is moved in the second direction and detects the gray level of the background image of the document in the operation of step 14. Whether the edge detection is completed may be determined by determining whether the image sensor moving from the one side to the opposite side stops completely, or may be determined by an edge detection completion signal.

The second direction is opposite to the first direction in which the image sensor moves to detect an edge. In the operation of step 12, the image sensor reads the image while moving from the one side to the opposite side to detect the edge of the document, and stops at the opposite side after reading the image. Thereafter, the image sensor waiting at the opposite side, then moves to the original side, reads the image, and detects the gray level of the background image of the document from the read image in the operation of step 14.

FIG. 3 is a flowchart 14A of an embodiment of the operation of step 14 shown in FIG. 1, which includes reading the image of the document using the image sensor, and detecting the gray level of the background image in the operations of steps 30 through 34.

Background image detection parameters used to detect a gray level of a background image are first set in the operation of step 30. Examples of the background image detection parameters may include a threshold gray level used to determine a gray level of a background image, and other usual parameters that can be set to detect the gray level of the background image. The threshold gray level is a reference value used to determine whether an image having a certain gray level is a background image.

After the operation of step 30, the image sensor is moved in the second direction and reads the image of the document in the operation of step 32. That is, the image sensor which stopped at the opposite side after performing the operation of step 12, moves to its original position and reads the image.

After the operation of step 32, the gray level of the background image of the document is detected from the read image based on the background image detection parameters in the operation of step 34. Since the detection of the gray level of the background image is performed in a conventional manner, a detailed description thereof will be omitted.

The gray level of the background image can be changed into a gray level corresponding to white, and therefore, the document can be scanned into an image having a white background. That is, during a scan, the background image is removed from the document by changing the gray level of the background image into the gray level corresponding to white.

In another embodiment of the present invention, the order of performing the operations of steps 12 and 14 may be changed. That is, the image sensor may be moved in the first direction to detect the gray level of the background image of the document, and then may be moved in the second direction to detect the edge of the document. The details of each operation are otherwise substantially the same as described above, and thus a detailed description thereof will be omitted.

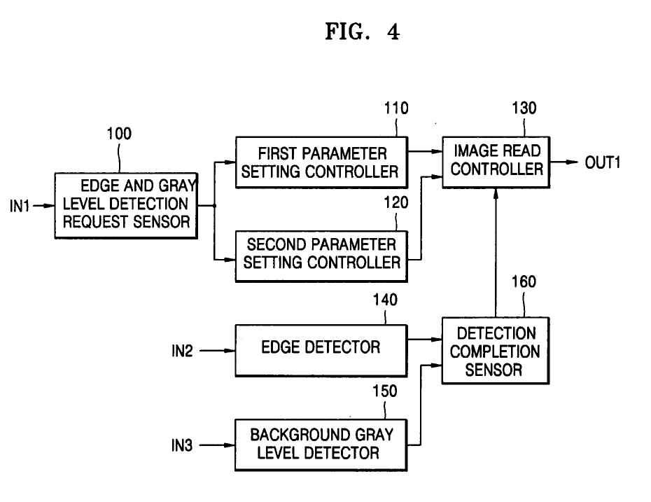

Hereinafter, an image scanning apparatus according to an embodiment of the present invention will be described with reference to the accompanying drawings. Referring to FIG. 4, an image scanning apparatus according to an embodiment of the present invention includes an edge and gray level detection request sensor 100, a first parameter setting controller 110, a second parameter setting controller 120, an image read controller 130, an edge detector 140, a background gray level detector 150, and a detection completion sensor 160.

The edge and gray level detection request sensor 100 senses whether there is a request to detect both an edge of a document and a gray level of a background image of the document together. The edge and gray level detection request sensor 100 senses whether an edge detection request signal and a background image removal request signal are input by a user through an input terminal IN1, and outputs a concurrent request sensing signal as a result of the sensing to both of the first and second parameter setting controllers 110 and 120.

The first parameter setting controller 110 controls the setting of the edge detection parameters for edge detection. In response to the concurrent request sensing signal received from the edge and gray level detection request sensor 100, the first parameter setting controller 110 controls the setting of the edge detection parameters selected by the user to be used to detect the edge of the document, and outputs a first setting signal as a control result to the image read controller 130.

The second parameter setting controller 120 controls the setting of the background image detection parameters for the detection of a gray level. In response to the concurrent request sensing signal received from the edge and gray level detection request sensor 100, the second parameter setting controller 120 controls the setting of the background image detection parameters selected by the user to be used to detect the gray level, and outputs a second setting signal as a control result to the image read controller 130.

The image read controller 130 controls image reading using an image sensor (not shown) that moves in a first direction and a second direction, wherein the first and second directions are opposite to each other.

In response to either of the first and second setting signals received from the first and second parameter setting controllers 110 and 120, respectively, the image read controller 130 outputs a first read control signal to the image sensor through an output terminal OUT1 for controlling the image sensor to read an image of the document. In response to the first read control signal, the image sensor moves in the first direction and reads the image of the document.

In response to an edge detection completion signal or gray level detection completion signal received from the detection completion sensor 160, the image read controller 130 outputs a second read control signal to the image sensor through the output terminal OUT1 for controlling the image sensor to read the image of the document. Here, the image sensor has completed reading the image while moving in the first direction, and the image sensor is now positioned at a side opposite to its original position. In response to the second read control signal, the image sensor positioned at the opposite side, then moves in the second direction and reads the image of the document.

The edge detector 140 detects the edge of the document. The edge detector 140 receives the image read by the image sensor through an input terminal IN2 and detects the edge of the document using the read image. The edge detector 140 then outputs an edge detection result to the detection completion sensor 160.

The background gray level detector 150 detects the gray level of the background image of the document. The background gray level detector 150 receives the image read by the image sensor through an input terminal IN3 and detects the gray level of the background image of the document using the read image. The background gray level detector 150 then outputs a gray level detection result to the detection completion sensor 160.

The detection completion sensor 160 senses whether the edge detector 140 completes detecting the edge of the document, and whether the background gray level detector 150 completes detecting the gray level of the background image. The detection completion sensor 160 senses the completion of the edge detection according to the edge detection result received from the edge detector 140, and outputs an edge detection completion signal to the image read controller 130 as a sensing result. The detection completion sensor 160 also senses that the detection of the gray level of the document's background image is completed according to the gray level detection result received from the background gray level detector 150, and outputs a gray level detection completion signal to the image read controller 130 as a sensing result.

As described above, according to an image scanning method and apparatus of the present invention, both document edge detection and background image removal can be performed by only a single operation of an image sensor. Therefore, scanning time is reduced, and greater convenience is provided for users.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. An image scanning method using an image sensor for reading an image of a document, the image scanning method comprising:
moving the image sensor in a first direction and detecting an edge of a document; and
moving the image sensor in a second direction and detecting a gray level of a background image of the document.

2. The image scanning method of claim 1, wherein the second direction is opposite to the first direction.

3. The image scanning method of claim 1, further comprising the steps of:
sensing a request to detect both the edge of the document and the gray level of the background image together,
wherein if the request to detect both is sensed, the step of moving the image sensor in the first direction and detecting the edge is performed.

4. The image scanning method of claim 1, wherein the step of moving the image sensor in the first direction and detecting the edge comprises the steps of:
moving the image sensor in the first direction and reading an image of the document; and
detecting the edge of the document using the read image.

5. The image scanning method of claim 4, further comprising the step of:
setting at least one edge detection parameter for document edge detection before the step of moving the image sensor in the first direction and reading the image.

6. The image scanning method of claim 1, wherein the step of moving the image sensor in the second direction and detecting the gray level comprises the steps of:
moving the image sensor in the second direction and reading an image of the document; and
detecting the gray level of the background image using the read image.

7. The image scanning method of claim 6, further comprising the step of:
setting at least one background image detection parameter for detecting the gray level of the background image before the step of moving the image sensor in the second direction and reading the image.

8. The image scanning method of claim 1, wherein an order of performing the step of moving the image sensor in the first direction and reading the image, and the step of moving the image sensor in the second direction and reading the image, can be varied.

9. An image scanning apparatus using an image sensor for reading an image of a document, the image scanning apparatus comprising:
an image read controller for controlling image reading by using the image sensor moving in a first direction and a second direction;
an edge detector for detecting an edge of a document;
a background gray level detector for detecting a gray level of a background image of the document; and
a detection completion sensor for sensing whether the edge detector completes detecting the edge of the document, and for sensing whether the background gray level detector completes detecting the gray level of the background image.

10. The image scanning apparatus of claim 9, further comprising:
an edge and gray level detection request sensor for sensing a request to detect both the edge of the document and the gray level of the background image together.

11. The image scanning apparatus of claim 9, further comprising:
a first parameter setting controller for controlling a setting of at least one edge detection parameter used to detect the edge of the document; and
a second parameter setting controller for controlling a setting of at least one background image detection parameter used to detect the gray level of the background image.
